(19) United States
(12) Patent Application Publication
(10) Pub. No.: US 2026/0355045 A1
(43) Pub. Date: Nov. 12, 2026

(54) CONTROL METHOD FOR INFLATING AND DEFLATING AIR BAG AND MASSAGER

(71) Applicant: Reestar International Limited, Hong Kong (CN)

(72) Inventors: Xili Wu, Hong Kong (CN); Baoyan Wei, Hong Kong (CN); Gaoming Liang, Hong Kong (CN)

(21) Appl. No.: 19/201,962

(22) Filed: May 8, 2025

(51) Int. Cl. A61H 9/00

(52) U.S. Cl. CPC A61H 9/0078; A61H 2201/501; A61H 2201/5056; A61H 2201/5071; A61H 2205/12

(57) ABSTRACT

A control method for inflating and deflating an air bag is disclosed. The air bag is applied to a massager. The massager includes an inflation/deflation assembly for inflating and deflating the air bag. The air bag is configured to massage a user's body part to be massaged. The control method for inflating and deflating the air bag includes: controlling the inflation/deflation assembly to inflate the air bag in response to an acquired operation instruction; detecting an air pressure value of the air bag and an inflation duration of the air bag; controlling the inflation/deflation assembly to stop inflating the air bag when the air pressure value reaches a preset air pressure value or when the inflation duration reaches a preset inflation duration; and controlling the inflation/deflation assembly to deflate the air bag.

### FIELD

The present disclosure relates to the technical field of massagers, and particularly to a control method for inflating and deflating an air bag and a massager.

### BACKGROUND

Massagers are equipped with air bags that massage a user's target body part through cyclic inflation and deflation. However, sizes of users' target body parts vary. For example, when the target body part is a foot, for users with smaller feet, the air bag has a larger expansion space, resulting in a weaker massage pressure, while for users with larger feet, the air bag has a smaller expansion space, resulting in a stronger massage pressure. The massagers in related art fail to meet diverse massage needs of different users.

### SUMMARY

A control method for inflating and deflating an air bag is provided in the present disclosure. The air bag is applied to a massager. The massager includes an inflation/deflation assembly for inflating and deflating the air bag. The air bag is configured to massage a user's body part to be massaged. The control method for inflating and deflating the air bag includes: controlling the inflation/deflation assembly to inflate the air bag in response to an acquired operation instruction, wherein the acquired operation instruction is one of at least one operation instruction; detecting an air pressure value of the air bag and an inflation duration of the air bag; controlling the inflation/deflation assembly to stop inflating the air bag when the air pressure value reaches a preset air pressure value or when the inflation duration reaches a preset inflation duration; and controlling the inflation/deflation assembly to deflate the air bag.

A massager is provided in the present disclosure. The massager includes an air bag, an inflation/deflation assembly, an air pressure sensor, a timing circuit, and a control circuit. The air bag is configured to fit a user's body part to be massaged. The inflation/deflation assembly is connected to the air bag and configured to inflate or deflate the air bag. The air pressure sensor is configured to detect an air pressure value in the air bag. The timing circuit is configured to detect an inflation duration of the inflation/deflation assembly. The control circuit is electrically connected to the air pressure sensor, the timing circuit, and the inflation/deflation assembly. The control circuit is configured to control the inflation/deflation assembly to inflate the air bag in response to an acquired operation instruction, wherein the acquired operation instruction is one of at least one operation instruction. The control circuit is also configured to control the inflation/deflation assembly to stop inflating the air bag when the air pressure value reaches a preset air pressure value or when the inflation duration reaches a preset inflation duration, and control the inflation/deflation assembly to deflate the air bag.

### BRIEF DESCRIPTION OF THE DRAWINGS

To provide a clearer illustration of the technical solutions in the embodiments of the present disclosure, a brief introduction will be given to the drawings used in the description of the embodiments. It is obvious that the drawings described below are merely some embodiments of the present disclosure, and for those skilled in the art, other drawings can be obtained based on these drawings without creative efforts.

FIG. 1 is a structural view of a massager according to some embodiments of the present disclosure.

FIG. 2 is an exploded view of the massager shown in FIG. 1.

FIG. 3 is a structural view of an air bag massage mechanism in FIG. 2.

FIG. 4 is a structural view of an inflation/deflation assembly and air tubes in FIG. 3.

FIG. 5 is a structural view of a heel support in FIG. 2.

FIG. 6 is a structural view of a panel in FIG. 1.

FIG. 7 is a component block diagram of the massager according to some embodiments of the present disclosure.

FIG. 8 is a first flowchart of a control method for inflating and deflating an air bag according to some embodiments of the present disclosure.

FIG. 9 is a second flowchart of the control method for inflating and deflating the air bag according to some embodiments of the present disclosure.

FIG. 10 is a third flowchart of the control method for inflating and deflating the air bag according to some embodiments of the present disclosure.

FIG. 11 is a fourth flowchart of the control method for inflating and deflating the air bag according to some embodiments of the present disclosure.

### DETAILED DESCRIPTION

In order to make the objectives, technical solutions, and advantages of the embodiments of the present disclosure more clear, the following will clearly and completely describe the technical solutions in the embodiments of the present disclosure in combination with the accompanying drawings. Obviously, the described embodiments are only part of the embodiments of the present disclosure, not all of them. Based on the embodiments described in the present disclosure, all other embodiments obtained by ordinary skills in the art without creative work belong to the protection scope of the present disclosure.

In the embodiments of the present disclosure, descriptions involving “first”, “second”, etc. are only for the purpose of description, and cannot be understood as indicating or implying their relative importance or implicitly indicating the number of the indicated technical features. Thus, a feature defined as “first”, “second” may explicitly or implicitly include at least one such feature.

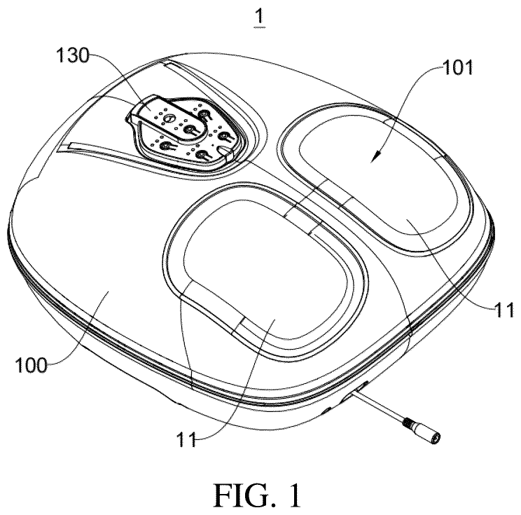

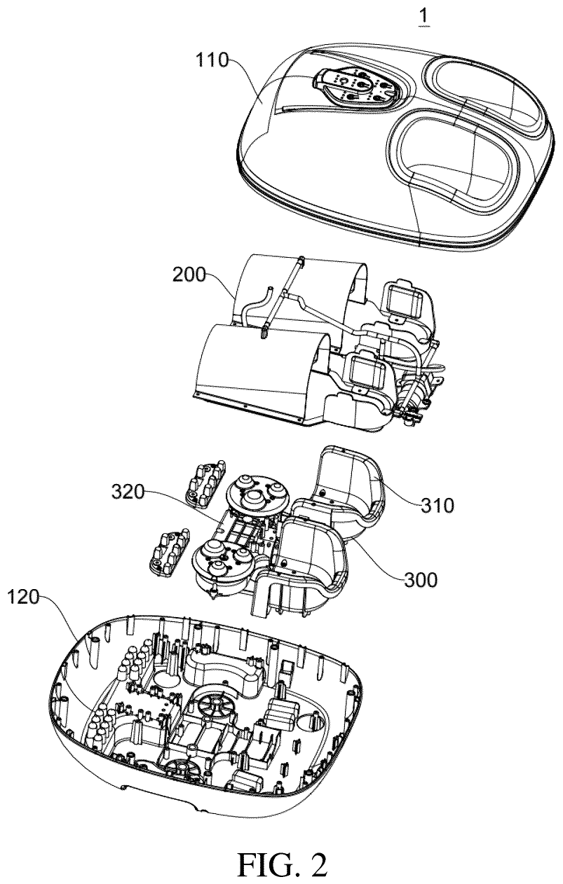

The present disclosure provides a massager. Referring to FIGS. 1 and 2, the massager 1 may include a housing 100 and an air bag massage mechanism 200. The air bag massage mechanism 200 massages a user's body part to be massaged by applying pressure. The user's body part to be massaged may be a foot, leg, waist, head, etc. In the present disclosure, the foot is used as an example for description. The massager 1 may further include a massage mechanism 300. The massage mechanism 300 may include a massage assembly 320. The massage assembly 320 is equipped with a massage head, and the massage mechanism 300 can massage the user's body part to be massaged, e.g., a sole of the foot, by rotating the massage head, thereby enhancing massage effect in coordination with the air bag massage mechanism 200.

The housing 100 may define an entrance 11 and an accommodation cavity 101 communicated to the entrance 11. The entrance 11 allows the user's foot to enter the accommodation cavity 101. The housing 100 may include an upper housing 110 and a lower housing 120. The entrance 11 is formed in the upper housing 110. The upper housing 110 and the lower housing 120 cooperatively define the accommodation cavity 101. The air bag massage mechanism 200 and the massage mechanism 300 are arranged in the accommodation cavity 101.

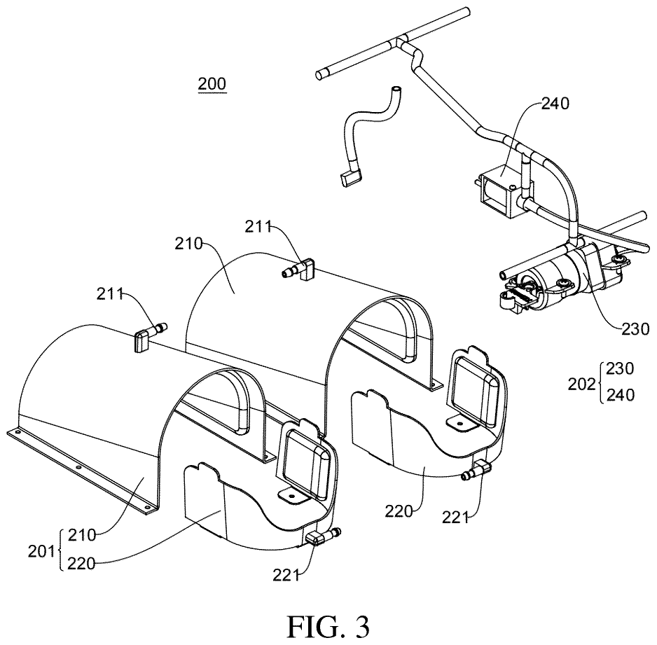

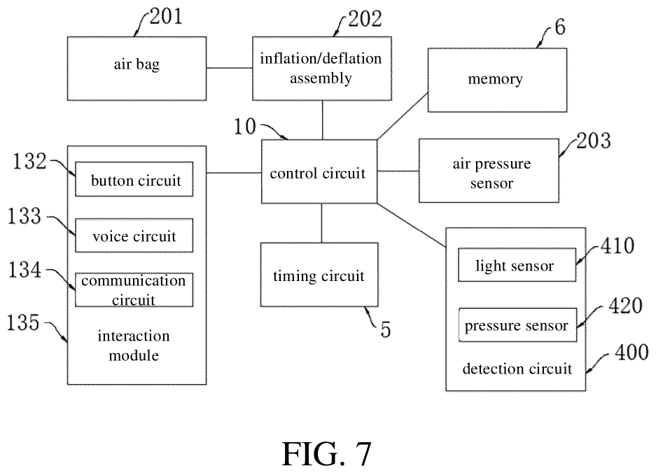

In some embodiments, referring to FIGS. 3 and 7, the air bag massage mechanism 200 may include an air bag 201 and an inflation/deflation assembly 202. The air bag 201 is arranged to fit the user's body part to be massaged, and the inflation/deflation assembly 202 is connected to the air bag 201 and configure to inflate or deflate the air bag 201. The massager 1 may further include a control circuit 10, which is electrically connected to the inflation/deflation assembly 202. The control circuit 10 can control an inflation or deflation of the air bag 201 to massage the user's foot.

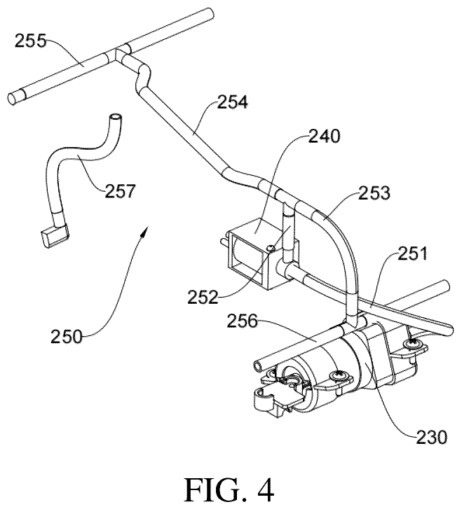

In some embodiments, referring to FIGS. 3, 4, and 7, the air bag 201 may include a first sub-air bag 210 and a second sub-air bag 220. The first sub-air bag 210 fits the user's foot dorsum, and the second sub-air bag 220 fits the user's heel. Each of the first sub-air bag 210 and the second sub-air bag 220 is connected to the inflation/deflation assembly 202. The inflation/deflation assembly 202 may include an air pump 230 and an air valve 240. The first sub-air bag 210 is connected to the air pump 230 and the air valve 240 via an air tube 250, and the second sub-air bag 220 is also connected to the air pump 230 and the air valve 240 via the air tube 250. Specifically, the first sub-air bag 210 may define two first inflation ports 211, and the second sub-air bag 220 may define two second inflation ports 221. The air pump 230 is communicated to the air valve 240 via a first air tube 251, and the air valve 240 is communicated to a third air tube 253 and a fourth air tube 254 via a second air tube 252. The third air tube 253 is connected to a sixth air tube 256. The sixth air tube 256 may have two ports. Each of the two ports of the sixth air tube 256 is connected to a respective one of the two second inflation ports 221, thereby establishing a connection between the sixth air tube 256 and the second sub-air bag 220. The fourth air tube 254 is connected to a fifth air tube 255. The fifth air tube 255 may have two ports. Each of the two ports of the fifth air tube 255 is connected to a respective one of the two first inflation ports 211, thereby establishing a connection between the fifth air tube 255 and the first sub-air bag 210. The massager 1 further includes an air pressure sensor 203. The first sub-air bag 210 are further connected to the air pressure sensor 203 via a seventh air tube 257, enabling the air pressure sensor 203 to detect an air pressure value of the air bag 201.

The control circuit 10 controls the air pump 230 to operate. When the air pump 230 starts inflation, an inflation port of the air valve 240 is open, and an exhaust port of the air valve 240 is closed. Air is delivered to the air valve 240 through the air tube and then transferred to the first sub-air bag 210 and the second sub-air bag 220, completing inflation of the first sub-air bag 210 and the second sub-air bag 220 and massaging the user's feet. When deflation is required, the control circuit 10 stops the air pump 230 and controls the air valve 240 to deflate, with the inflation port of the air valve 240 closed and the exhaust port of the air valve 240 open to deflate the first sub-air bag 210 and the second sub-air bag 220. Through repeated inflation and deflation, a compression massage can be applied to the user's feet.

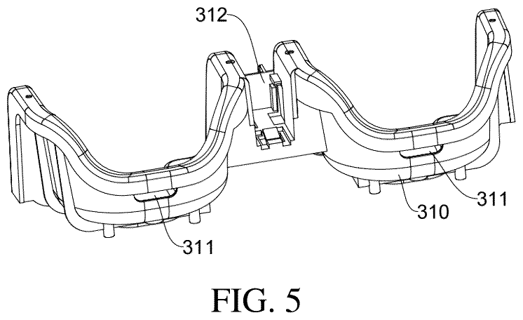

In some embodiments, referring to FIG. 5, the massager 1 may further include a heel support 310, which supports the user's feet, providing stable positioning and enhancing massage experience. The heel support 310 is arranged corresponding to the second sub-air bag 220. The sub-air bag 220 may be located on an inner wall of the heel support 310. A side wall of the heel support 310 defines an avoidance hole 311 for the sixth air tube 256 to pass through and connect to the second sub-air bag 220. The heel support 310 may include two heel support parts. An air valve mounting part 312 is arranged between the two heel support parts. The air valve 240 is mounted on the air valve mounting part 312 to enhance the installation stability of the air valve 240 and enable effective utilization of space. The air pump 230 may be arranged on the lower housing 120 and located at the rear side of the heel support 310. Of course, the present embodiment is not limited thereto.

Referring to FIGS. 3, 4, and 7, the massager 1 further includes an air pressure sensor 203 and a timing circuit 5. The air pressure sensor 203 is configured to detect an air pressure value in the air bag 201, and the timing circuit 5 is configured to detect an inflation duration or deflation duration of the inflation/deflation assembly 202. Each of the air pressure sensor 203 and the timing circuit 5 is electrically connected to the control circuit 10. The air pressure sensor 203 sends the air pressure value to the control circuit 10. The control circuit 10 is configured to control the inflation/deflation assembly 202 based on the air pressure value. The timing circuit 5 sends the inflation duration or the deflation duration to the control circuit 10. The control circuit 10 is configured to control the inflation/deflation assembly 202 based on the inflation duration or the deflation duration.

In some embodiments, referring to FIG. 7, an interaction module 135 is arranged on the upper housing 110 or in the housing 100 and is electrically connected to the control circuit 10. Users can interact with the massager 1 through the interaction module 135, such as inputting an operation instruction.

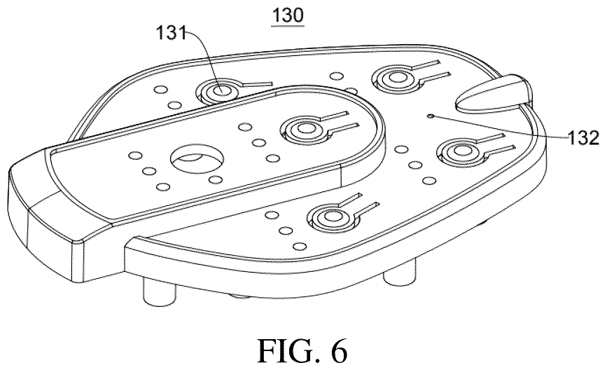

As an example, the interaction module 135 includes a button circuit 132. Referring to FIGS. 2, 6, and 7, the upper housing 110 is further arranged with a panel 130. The button circuit 132 is arranged on the panel 130 and includes a plurality of buttons 131. Each of the plurality of buttons 131 is configured to trigger a distinct function and send a distinct operation instruction to the control circuit 10. For example, the plurality of buttons 131 may include a plurality of function buttons, such as a “start/stop” button, a “mode selection” button, and an “air pressure adjustment” button. The user can select a massage mode or adjust parameters as needed by pressing a corresponding button 131. This physical button control method is simple and intuitive, convenient to operate, and provides a favorable user experience.

Additionally, the plurality of buttons 131 may further include a “settings” button. The user can press the “settings” button to set preferred massage information, such as a massage mode or massage parameters. The user can also create, delete, or select user accounts through the “settings” button, allowing personalized settings for the preferred massage information of different users. The massager 1 may further include a memory 6. The memory 6 can store massage information set by the user. The massager 1 can operate according to the massage mode and massage parameters preferred by the user currently using the massager 1, thereby enhancing comfort of the user during use.

As another example, referring to FIGS. 1, 6, and 7, the interaction module 135 includes a voice circuit 133. The voice circuit 133 may be arranged on the housing 100 or the panel 130. The voice circuit 133 includes a microphone and a voice recognition circuit. The microphone is configured to capture the user's voice, convert the user's voice into an electrical signal, and send the electrical signal to the voice recognition circuit for parsing. Then the voice recognition circuit sends the parsed electrical signal to the control circuit 10 to perform the corresponding operation. For instance, the user may say voice commands such as “start massage”, “switch to strong mode”, or “stop massage”, and the massager 1 automatically adjusts inflation and deflation operations of the air bag 201 based on the voice commands. This voice control method provides the user with a more convenient operating experience, especially suitable for situations where the user's hands are not free to operate the massager 1.

Furthermore, the voice circuit 133 may also recognize the user corresponding to a voiceprint feature carried in the electrical signal by analyzing the voiceprint feature. The memory 6 can store massage information for a plurality of users. The control circuit 10 can retrieve the massage information corresponding to the recognized user from the memory 6 and perform massage control based on the retrieved massage information, thereby providing a personalized massage experience for the user.

As a further example, the interaction module 135 further includes a communication circuit 134. The communication circuit 134 may be arranged on the housing 100 or the panel 130. The communication circuit 134 is capable of establishing a signal connection with a third-party smart device. The third-party smart device may be a smartphone, a tablet, a smartwatch, and the like. The user can control the massager 1 through an application (APP) on the third-party smart device. The communication circuit 134 can connect to the third-party smart device via Bluetooth, Wi-Fi, or other wireless communication protocols, enabling data transmission and command delivery. Users can select the massage mode, adjust an air pressure, and set the inflation duration through the APP on the third-party smart device, and transmit the operation instruction to the control circuit 10 via the communication circuit 134. This third-party smart device-based control approach not only offers a richer interface and more functions but also allows the user to control the massager 1 remotely, thereby further enhancing convenience and flexibility in use.

In some embodiments, referring to FIG. 7, the massager 1 further includes a detection circuit 400. The detection circuit 400 is electrically connected to the control circuit 10 and is configured to detect whether the user's body part to be massaged is placed in the massager 1. The detection circuit 400 can be implemented in various forms.

As an example, the detection circuit 400 includes a light sensor 410. The light sensor 410 is arranged in the massager 1 and located near the air bag 201. The light sensor 410 is configured to detect a light intensity around the air bag 201. When the user's body part to be massaged, such as the foot, is placed in the air bag 201, the light is blocked, causing a decrease in the light intensity detected by the light sensor 410. When the light intensity detected by the light sensor 410 falls below a preset light intensity threshold, the control circuit 10 determines that the user's body part to be massaged has been correctly positioned in the air bag 201. Thus, the light sensor 410 can be configured to detect whether the user's body part to be massaged is in the air bag 201. It should be noted that the body part to be massaged being placed in the air bag 201 should be understood as being in a massage space formed by the air bag 201.

As another example, the detection circuit 400 includes a pressure sensor 420. The pressure sensor 420 is arranged at a pressure-receiving position in the massager 1. For instance, the pressure sensor 420 is arranged on a side of the massage assembly 320 that is configured to contact the user's foot. When the user's foot is placed in the air bag 201, the user's foot is supported by the massage assembly 320, thus the pressure sensor 420 can detect a change in pressure. When a detected pressure value reaches a preset pressure threshold, the control circuit 10 determines that the user's body part to be massaged has been correctly positioned in the air bag 201. In this way, presence of the user's body part to be massaged in the air bag 201 can be detected via the pressure sensor 420.

As yet another example, the detection circuit 400 may include both the light sensor 410 and the pressure sensor 420. The control circuit 10 may determine whether the user's body part to be massaged is placed in the air bag 201 by combining the light intensity detected by the light sensor 410 and the pressure value detected by the pressure sensor 420. For instance, when the light intensity is below the preset light intensity threshold and the pressure value reaches the preset pressure threshold, the control circuit 10 determines that the user's body part to be massaged has been correctly positioned in the air bag 201. In this example, determining whether the user's body part to be massaged has been correctly positioned in the air bag 201 by integrating data from more than one sensor helps improve accuracy of a determination result.

To facilitate understanding of the control method for inflating and deflating the air bag 201 provided in the embodiments of the present disclosure, the control method is described in detail below with reference to the aforementioned massager 1.

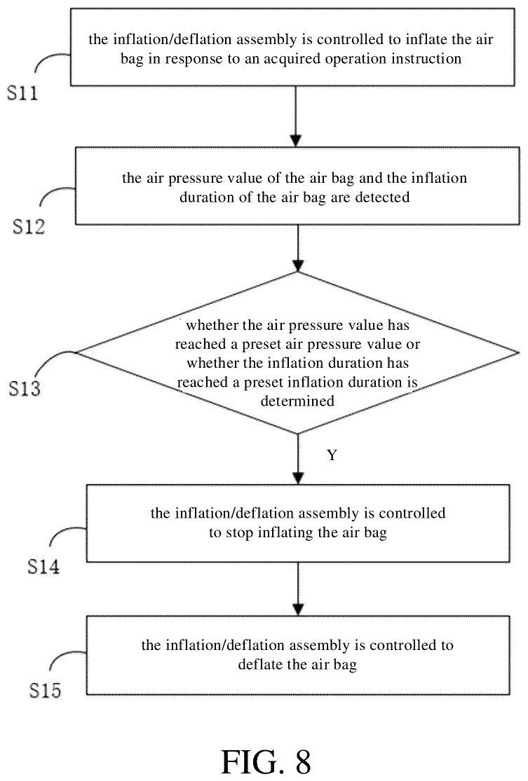

Referring to FIG. 8, the control method for inflating and deflating the air bag 201 provided by the embodiments of the present disclosure includes the following operations S11 to S15.

In the operation S11, the inflation/deflation assembly 202 is controlled to inflate the air bag 201 in response to an acquired operation instruction.

In the operation S12, the air pressure value of the air bag 201 and the inflation duration of the air bag 201 are detected.

In the operation S13, whether the air pressure value has reached a preset air pressure value or whether the inflation duration has reached a preset inflation duration is determined.

In the operation S14, the inflation/deflation assembly 202 is controlled to stop inflating the air bag 201 when the air pressure value reaches the preset air pressure value or the inflation duration reaches the preset inflation duration.

In the operation S15, the inflation/deflation assembly 202 is controlled to deflate the air bag 201.

Specifically, during a power-on period of the massager 1, the control circuit 10 controls the inflation/deflation assembly 202 to inflate the air bag 201 in response to the acquired operation instruction. Based on the acquired operation instruction, the control circuit 10 outputs a control signal to the inflation/deflation assembly 202, thereby controlling the inflation/deflation assembly 202 to inflate the air bag 201. During inflation, the air pressure sensor 203 continuously monitors the air pressure value in the air bag 201 and transmits the air pressure value to the control circuit 10. Meanwhile, the timing circuit 5 continuously records the inflation duration of the air bag 201 and transmits the inflation duration to the control circuit 10. The control circuit 10 compares the air pressure value in the air bag 201 with the preset air pressure value to determine whether the air pressure value in the air bag 201 has reached the preset air pressure value. The preset air pressure value corresponds approximately to an air pressure value required to achieve a standard massage intensity. In other words, when the air pressure value in the air bag 201 reaches the preset air pressure value, a massage force provided by the air bag 201 is roughly equivalent to a recommended massage intensity for a standard foot. The preset air pressure value can be pre-stored in the memory 6. The control circuit 10 can retrieve the preset air pressure value from the memory 6 for the comparison between the air pressure value in the air bag 201 with the preset air pressure value. The control circuit 10 also compares the inflation duration with a preset inflation duration to determine whether the inflation duration has reached the preset inflation duration. The preset inflation duration is slightly longer than a standard inflation duration needed for the air bag 201 to achieve the standard massage intensity for a standard foot. The preset inflation duration may also be pre-stored in the memory 6, and retrieved by the control circuit 10 for the comparison between the inflation duration with the preset inflation duration. When the air pressure value in the air bag 201 reaches the preset air pressure value, or when the inflation duration reaches the preset inflation duration, the control circuit 10 controls the inflation/deflation assembly 202 to stop inflating and to start deflating the air bag 201. By repeating these operations, cyclic inflation and deflation of the air bag 201 can be realized, thereby massaging the user's body part to be massaged. When determining that neither the air pressure value has reached the preset air pressure value nor the inflation duration has reached the preset inflation duration, the control circuit 10 continues to control the inflation/deflation assembly 202 to keep inflating the air bag 201 until the air pressure value has reached the preset air pressure value or the inflation duration has reached the preset inflation duration, at which point the control circuit 10 controls the inflation/deflation assembly 202 to stop inflation.

It should be noted that the determination of whether the air pressure value has reached the preset air pressure value may also be performed by the air pressure sensor 203. Then the air pressure sensor 203 transmits a first determination result to the control circuit 10 for execution of operations corresponding to the first determination result. Similarly, the determination of whether the inflation duration has reached the preset inflation duration may be performed by the timing circuit 5. The timing circuit 5 then transmits a second determination result to the control circuit 10 for further action corresponding to the second determination result.

It can be understood that, taking the user's foot as the user's body part to be massaged, when the user's foot is larger than a standard size, the air pressure value in the air bag 201 can reach the preset air pressure value in a shorter time, thus enabling the user to experience the standard massage intensity in less time than the standard inflation duration. Conversely, when the user's foot is smaller than the standard size, the air pressure value of the air bag 201 requires a longer time to reach the preset air pressure value required to provide the standard massage intensity. Therefore, in this embodiment, two determination criteria are used—whether the air pressure value reaches the preset air pressure value, and whether the inflation duration reaches the preset inflation duration. When either of two determination criteria is met, the control circuit 10 stops inflating the air bag 201. In this way, the massager 1 can provide the standard massage intensity for users with foot sizes larger than, equal to, or smaller than the standard size, thereby meeting diverse massage needs of various users.

The inflation and deflation control method for air bag 201 provided in this embodiment enables the inflation/deflation assembly 202 to respond to the acquired operation instruction for inflating the air bag 201. When the air pressure value in the air bag 201 reaches the preset air pressure value or the inflation duration reaches the preset inflation duration, the control circuit 10 control the inflation/deflation assembly 202 to stop inflation and start deflation. In this way, compression massage on the user's body part to be massaged can be realized through controlled inflation and deflation of the inflation/deflation assembly 202, and by managing both the air pressure value and the inflation duration during the inflation process, the massage force can be appropriately adjusted for different users, enhancing overall massage experience.

In some embodiments, the control method for inflating and deflating of the air bag 201 further includes the following operation. The preset air pressure value and the preset inflation duration corresponding to the acquired operation instruction are determined. This operation may be executed before the operation S12 or concurrently with the operation S12, and is not limited. After acquiring the operation instruction, the control circuit 10 sends the control signal corresponding to the acquired operation instruction to the inflation/deflation assembly 202, and reads from the memory 6 the preset air pressure value and preset inflation duration corresponding to the acquired operation instruction. In this way, the control circuit 10 can perform different control operations according to different operation instructions.

In some embodiments, the number of the at least one operation instruction is more than one, the number of groups of the preset air pressure value and the preset inflation duration is more than one. At least one operation instruction has a different preset air pressure value and/or preset inflation duration compared to other instructions. In other words, the preset air pressure value corresponds to one of the more than one operation instruction is different from the preset air pressure value corresponds to another of the more than one operation instruction, and/or the preset inflation duration corresponds to the one of the more than one operation instruction is different from the preset inflation duration corresponds to the another of the more than one operation instruction. The more than one operation instruction can take various forms.

As an example, the more than one operation instruction corresponds to a plurality of inflation massage levels. For instance, the plurality of inflation massage levels may include three levels: “gentle massage”, “medium massage”, and “strong massage”. The inflation massage level of “gentle massage” corresponds to a first operation instruction, the inflation massage level of “medium massage” corresponds to a second operation instruction, and the inflation massage level of “strong massage” corresponds to a third operation instruction. The preset air pressure value corresponding to the first operation instruction is lower than the preset air pressure value corresponding to the second operation instruction, and the preset air pressure value corresponding to the second operation instruction is lower than the preset air pressure value corresponding to the third operation instruction. The preset inflation duration corresponding to the first operation instruction is shorter than the preset inflation duration corresponding to the second operation instruction, and the preset inflation duration corresponding to the second operation instruction is shorter than the preset inflation duration corresponding to the third operation instruction. In this way, each inflation massage level corresponds to a distinct preset air pressure value and a distinct preset inflation duration from another inflation massage level, thereby achieving different degrees of massage effects.

As another example, the more than one operation instruction corresponds to a plurality of preset roles. The plurality of preset roles may include three roles: elderly, young, and child. The preset role of elderly corresponds to a first operation instruction, the preset role of young corresponds to a second operation instruction, and the preset role of child corresponds to a third operation instruction. The preset air pressure value corresponding to the first operation instruction is lower than the preset air pressure value corresponding to the second operation instruction, and the preset air pressure value corresponding to the second operation instruction is higher than the preset air pressure value corresponding to the third operation instruction. The preset inflation duration corresponding to the first operation instruction is shorter than the preset inflation duration corresponding to the second operation instruction, and the preset inflation duration corresponding to the second operation instruction is longer than the preset inflation duration corresponding to the third operation instruction. The preset air pressure value corresponding to the first operation instruction and the preset air pressure value corresponding to the third operation instruction may be equal or unequal, the preset inflation duration corresponding to the first operation instruction and the preset inflation duration corresponding to the third operation instruction may also be equal or unequal, and the present disclosure imposes no limitation on this. When using the massager 1, the user can first input a role into the massager 1, for example, by selecting the role through a button 131 on the massager 1, or selecting the role on the third-party smart device, with the third-party smart device then sending role information to the communication circuit 134. After inputting the role, the user can further operate the massager 1 to activate the massage function, or the massager 1 may directly activate the massage function based on the role input by the user. The preset air pressure values and preset inflation durations corresponding to the plurality of preset roles can be set before the massager 1 leaves the factory and stored in the memory 6 or can be set by the user. It should be noted that in addition that the plurality of preset roles include elderly, young, and child, each individual user of the massager 1 may also be treated as a preset role, and the present disclosure imposes no limitation on this. It is understandable that massage needs and physical conditions of different preset roles vary, thus the massager 1 can adjust the preset air pressure value and preset inflation duration according to the operation instruction corresponding to each preset role. In this way, the user can selectively choose a suitable preset role, allowing the massager 1 to provide the most appropriate massage experience for the selected preset role.

As yet another example, the more than one operation instruction corresponds to a plurality of preset modes. The plurality of preset modes may include three modes: “fast mode,” “medium mode,” and “slow mode.” Under different modes, the number of inflation and deflation cycles of the air bag 201 per unit time differs. The number of inflation and deflation cycles under the fast mode is higher than the number of inflation and deflation cycles under the medium mode, and the number of inflation and deflation cycles under the medium mode is higher than the number of inflation and deflation cycles under the slow mode. The fast mode corresponds to a first operation instruction, the medium mode corresponds to a second operation instruction, and the slow mode corresponds to a third operation instruction. The preset air pressure values corresponding to various operation instructions may be the same or various to each other, and the preset inflation durations corresponding to different operation instructions may be the same or different to each other. In this example, each preset mode is targeted at a distinct massage need and application scenario. The massager 1 can adjust the preset air pressure value and preset inflation duration based on the operation instruction corresponding to each preset mode, thereby achieving a massage effect consistent with the preset mode to meet the user's needs in different situations.

It is understood that the plurality of inflation massage levels, the plurality of preset roles, and the plurality of preset modes can be freely combined to provide the user with a richer and more personalized massage experience. For example, the more than one operation instruction may include a plurality of operation instructions corresponding to “gentle massage” under the “fast mode”, “medium massage” under the “fast mode”, and “strong massage” under the “fast mode”. As another example, the more than one operation instruction may include a plurality of operation instructions corresponding to “fast mode” under the preset role of young, “medium mode” under the preset role of young, and “slow mode” under the preset role of young.

After acquiring the operation instruction, the control circuit 10 may read the preset air pressure value and the preset inflation duration corresponding to the acquired operation instruction from the memory 6, and then control the inflation and deflation process of the air bag 201 based on the read preset air pressure value and preset inflation duration.

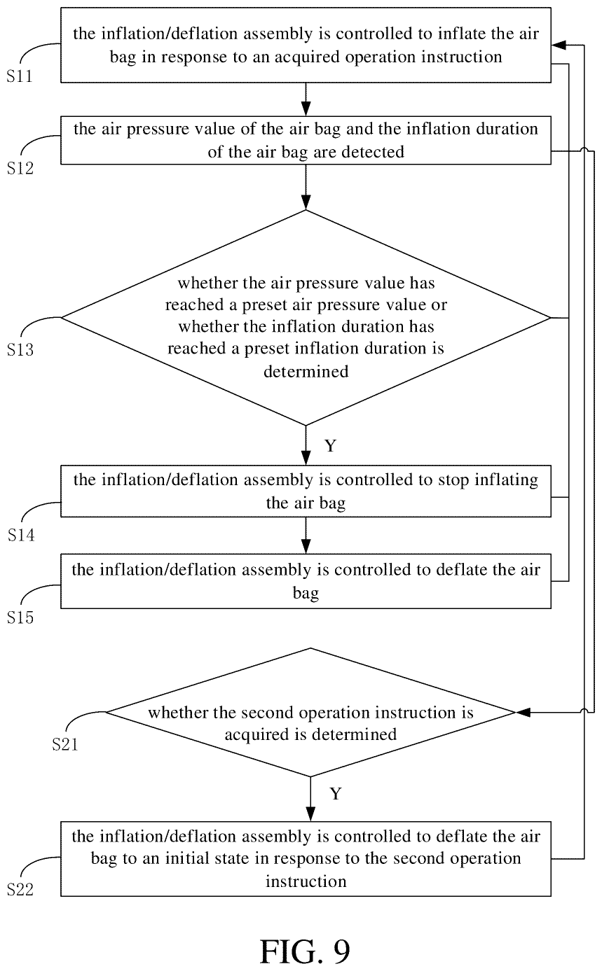

In some embodiments, the at least one operation instruction includes a first operation instruction and a second operation instruction. Referring to FIG. 9, the control method for inflating and deflating the air bag 201 further includes the following operations S21 to S22.

In the operation S21, whether the second operation instruction is acquired is determined during an operation of the inflation/deflation assembly 202 controlled in response to the first operation instruction.

In the operation S22, the inflation/deflation assembly 202 is controlled to deflate the air bag 201 to an initial state in response to the second operation instruction when the second operation instruction is acquired.

After the operation S22 is executed, the control circuit 10 returns to execute the operation S11. In the operation S11, the inflation/deflation assembly 202 is controlled to inflate the air bag 201 in response to the acquired operation instruction. In this case, the second operation instruction serves as the acquired operation instruction.

In this embodiment, the second operation instruction is different from the first operation instruction. For example, the first operation instruction is an instruction to activate the “gentle massage”, and the second operation instruction is an instruction to activate the “strong massage”. As another example, the first operation instruction corresponds to an instruction for young, and the second operation instruction corresponds to an instruction for elderly. As another example, the first operation instruction is an instruction to activate the “slow mode”, and the second operation instruction is an instruction to activate the “medium mode”.

During the operation of the inflation/deflation assembly 202 controlled by the control circuit 10 in response to the first operation instruction, when the second operation instruction is received, the control circuit 10 immediately responds to the second operation instruction. Specifically, the control circuit 10 controls the inflation/deflation assembly 202 to perform the deflation operation on the air bag 201 until an air pressure of the air bag 201 drops to the initial state, that is, the air bag 201 returns to an uninflated state or a state with only a small amount of gas. After completing the above deflation operation, the control circuit 10 controls the inflation/deflation assembly 202 to inflate the air bag 201 based on the newly acquired operation instruction, i.e., the second operation instruction. Furthermore, the control circuit 10 regulates the inflation operation of the air bag 201 based on the preset air pressure value and the preset inflation duration corresponding to the second operation instruction. When no second operation instruction is acquired during the operation of the inflation/deflation assembly 202 controlled by the control circuit 10 in response to the first operation instruction, the control circuit 10 continues to regulate the inflation of the air bag 201 based on the preset air pressure value and the preset inflation duration corresponding to the first operation instruction, until the second operation instruction is received and the inflation/deflation assembly 202 is then controlled to perform the deflation operation on the air bag 201. In this embodiment, the massager 1 can flexibly respond to the user's real-time operation instructions during the inflation and deflation operation. The user can interrupt a current massage operation and readjust massage parameters at any time according to actual, thereby achieving a more flexible and personalized massage experience.

It should be noted that during the operation of the inflation/deflation assembly 202 controlled by the control circuit 10 in response to the first operation instruction, when acquiring the second operation instruction, the control circuit 10 is already controlling the air bag 201 to be deflated to the initial state, then the control circuit 10 directly responds to the second operation instruction to control the inflation/deflation assembly 202 to inflate the air bag 201, without executing an action of controlling the inflation/deflation assembly 202 to deflate the air bag 201 again. To implement this function, at the moment receiving the second operation instruction, the control circuit 10 may first determine whether the air bag 201 is in the initial state. When the air bag 201 is in the initial state, the control circuit 10 directly responds to the second operation instruction to control the inflation/deflation assembly 202 to inflate the air bag 201. When the air bag 201 is not in the initial state, the control circuit 10 first executes the action of controlling the inflation/deflation assembly 202 to deflate the air bag 201. In this way, unnecessary operations can be omitted and a response speed of the massager 1 can be improved.

In some embodiments, a specific operation of controlling the inflation/deflation assembly 202 to deflate the air bag 201 to the initial state in response to the second operation instruction includes one of the following two methods.

The first method involves controlling the inflation/deflation assembly 202 to deflate the air bag 201 for a preset reset deflation duration in response to the second operation instruction. When the control circuit 10 receives the second operation instruction, the inflation/deflation assembly 202 starts the deflation operation on the air bag 201 and continues the deflation operation for the preset reset deflation duration. The preset reset deflation duration is determined based on factors such as a capacity of the air bag 201, a deflation rate, and a current air pressure value of the air bag 201, ensuring that the air bag 201 can safely deflate to the initial state in a reasonable time. The second method involves controlling the inflation/deflation assembly 202 to deflate the air bag 201 to a preset reset air pressure value in response to the second operation instruction. When the control circuit 10 receives the second operation instruction, the inflation/deflation assembly 202 performs the deflation operation on the air bag 201 until the air pressure of the air bag 201 drops to the preset reset air pressure value. The preset reset air pressure value is close to an air pressure value of the air bag 201 in a natural state when the air bag 201 is uninflated. By setting the preset reset air pressure value as a termination condition for deflation, it can be ensured that the air bag 201 precisely reaches the initial state during the deflation operation, while also avoiding over-deflation or under-deflation, thereby ensuring stability and reliability of the massager 1.

In some embodiments, when the massager 1 is powered on, an initialization deflation operation is automatically started. Specifically, the control circuit 10 may control the inflation/deflation assembly 202 to perform the deflation operation on the air bag 201 until one of the following two conditions is met.

The first condition involves the air bag 201 being deflated for a preset power-on deflation duration. When the massager 1 is powered on, the inflation/deflation assembly 202 performs the deflation operation on the air bag 201 and continues the deflation operation for the preset power-on deflation duration. The preset power-on deflation duration may also be determined based on factors such as the capacity of the air bag 201, the deflation rate, and the current air pressure value of the air bag 201. Another method involves when the massager 1 is powered on, the inflation/deflation assembly 202 deflating the air bag 201 until the air pressure value of the air bag 201 drops to a preset power-on air pressure value. The preset power-on air pressure value may be determined based on factors such as the initial state of the air bag 201, design requirements of the massager 1, and user experience. By deflating the air bag 201 for the preset power-on deflation duration or to the preset power-on air pressure value, it can be ensured that the air bag 201 quickly and safely releases any remaining internal gas at startup, thereby ensuring that a next inflation can reach an expected inflation state and improving massage effect.

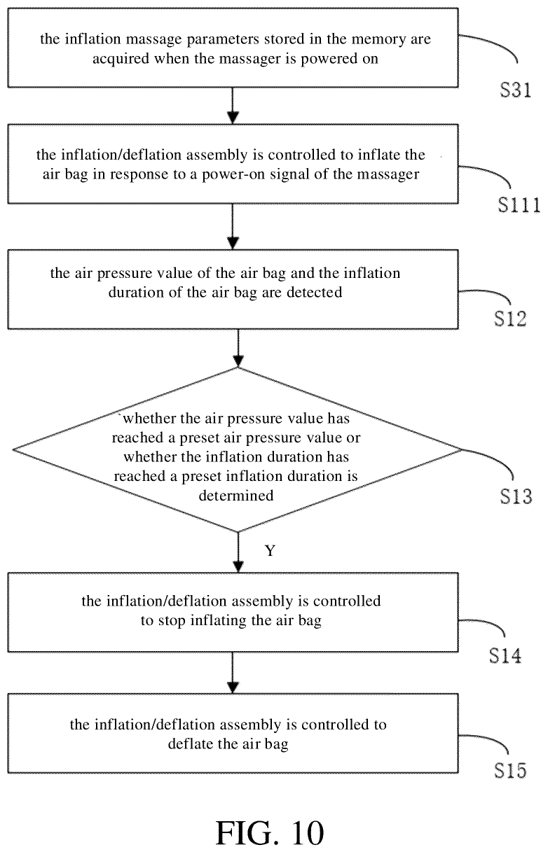

In some embodiments, the memory 6 stores inflation massage parameters used a last time before the massager 1 was powered off. The inflation massage parameters include the preset air pressure value and the preset inflation duration, and may further include working modes, such as “strong mode”, “fast mode”, etc. Referring to FIG. 10, the control method for inflating and deflating the air bag 201 further includes the following operations S31 and S111.

In the operation S31, the inflation massage parameters stored in the memory 6 are acquired when the massager 1 is powered on.

The operation S11, in which the inflation/deflation assembly 202 is controlled to inflate the air bag 201 in response to the acquired operation instruction, includes the operation S111.

In the operation S111, the inflation/deflation assembly 202 is controlled to inflate the air bag 201 in response to a power-on signal of the massager 1.

When the massager 1 is powered on, the control circuit 10 acquires the inflation massage parameters stored in the memory 6 before a last power-off of the massager 1. In addition, after the massager 1 is powered on, the control circuit 10 receives the power-on signal. As a form of operation instruction, the power-on signal triggers the control circuit 10 to control the inflation/deflation assembly 202 to cyclically inflate and deflate the air bag 201 according to the inflation massage parameters. In this way, when the massager 1 is powered on, the user does not need to perform any operation, and the massager 1 can automatically start the inflation operation based on the stored inflation massage parameters, allowing the air bag 201 to inflate according to last settings, thereby providing the user with a more convenient and personalized massage experience.

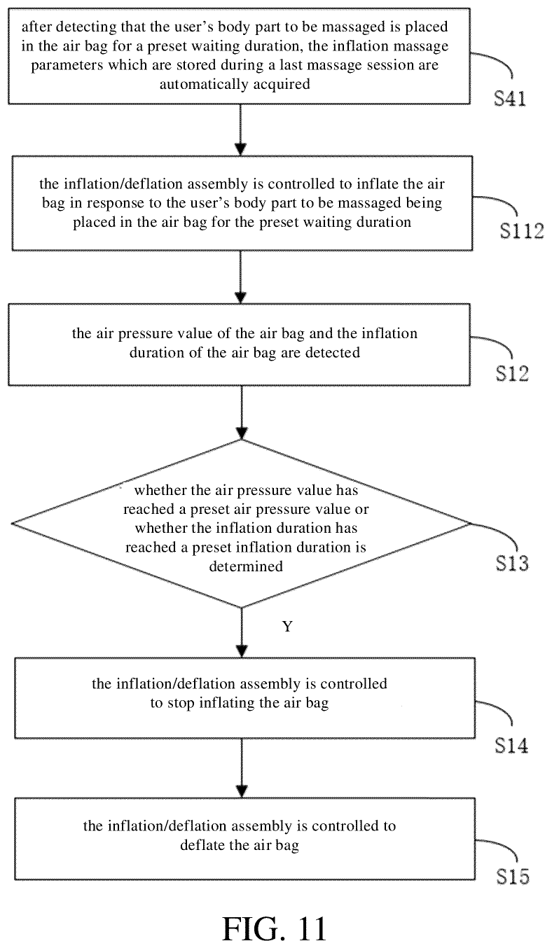

In some embodiments, as shown in FIG. 11, the control method for inflating and deflating the air bag 201 further includes the following operations S41 and S112.

In the operation S41, after detecting that the user's body part to be massaged is placed in the air bag 201 for a preset waiting duration, the inflation massage parameters which are stored during a last massage session are automatically acquired.

The operation S11, in which the inflation/deflation assembly 202 is controlled to inflate the air bag 201 in response to the acquired operation instruction, includes the operation S112.

In the operation S112, the inflation/deflation assembly 202 is controlled to inflate the air bag 201 in response to the user's body part to be massaged being placed in the air bag 201 for the preset waiting duration.

Specifically, the massager 1 may be in a sleep state, during which the control circuit 10 operates at low power, and detection circuit 400 and timing circuit 5 of the massager 1 may be periodically enabled to perform information detection. The detection circuit 400 detects whether the user's body part to be massaged is placed into the massager 1, and the timing circuit 5 records a placement duration that the user's body part to be massaged has been placed in the massager 1, particularly in the air bag 201. When the user's body part to be massaged is detected to be placed in the massager 1 and maintained for the preset waiting duration, the control circuit 10 can be awakened and can operate at normal power. At this point, the control circuit 10 can read the inflation massage parameters used during the last massage session, as stored in the memory 6. These inflation massage parameters may be understood as the parameters used by the control circuit 10 to control the inflation/deflation assembly 202 prior to a last sleep state. The inflation massage parameters may include the preset inflation duration and the preset air pressure value. Furthermore, the inflation massage parameters may further include the working mode, such as “strong mode”, “fast mode”, etc. A signal indicating that the placement duration of the user's body part to be massaged in the massager 1 reaches the preset waiting duration serves as a form of the operation instruction. In response to this signal, the control circuit 10 controls the inflation/deflation assembly 202 to cyclically inflate and deflate the air bag 201 according to the inflation massage parameters. In this embodiment, after determining that the user's body part to be massaged is placed in the massager 1 and maintained for the preset waiting duration, the control circuit 10 deems that the user has a massage demand. Therefore, the control circuit 10 invokes most recent inflation massage parameters and control the inflation/deflation assembly 202 to inflate the air bag 201 based on the most recent inflation massage parameters. In this way, the massager 1 can automatically start the massage function based on user needs, improving an automation degree of the massager 1, enhancing continuity of the user experience, and making the massage process smoother and more natural.

Finally, it should be noted that, the above embodiments are only intended to illustrate the technical solutions of the present disclosure, and not to limit them; although the present disclosure has been described in detail with reference to the foregoing embodiments, those of ordinary skill in the art should understand that: they can still make modifications to the technical solutions recorded in the foregoing embodiments, or perform equivalent replacements for some technical features; and such modifications or replacements do not cause the essence of the corresponding technical solutions to deviate from the spirit and scope of the technical solutions of the embodiments of the present disclosure.

What is claimed is:

1. A control method for inflating and deflating an air bag, wherein the air bag is applied to a massager, the massager comprises an inflation/deflation assembly for inflating and deflating the air bag, and the air bag is configured to massage a user's body part to be massaged; the control method for inflating and deflating the air bag comprises:
controlling the inflation/deflation assembly to inflate the air bag in response to an acquired operation instruction, wherein the acquired operation instruction is one of at least one operation instruction;
detecting an air pressure value of the air bag and an inflation duration of the air bag;
controlling the inflation/deflation assembly to stop inflating the air bag when the air pressure value reaches a preset air pressure value or when the inflation duration reaches a preset inflation duration; and
controlling the inflation/deflation assembly to deflate the air bag.

2. The control method for inflating and deflating the air bag according to claim 1, further comprising:
determining the preset air pressure value and the preset inflation duration corresponding to the acquired operation instruction.

3. The control method for inflating and deflating the air bag according to claim 2, wherein the number of the at least one operation instruction is more than one, and the number of groups of the preset air pressure value and the preset inflation duration is more than one;
the preset air pressure value corresponds to one of the more than one operation instruction is different from the preset air pressure value corresponds to another of the more than one operation instruction, and/or the preset inflation duration corresponds to the one of the more than one operation instruction is different from the preset inflation duration corresponds to the another of the more than one operation instruction.

4. The control method for inflating and deflating the air bag according to claim 3, wherein each of the more than one operation instruction corresponds to at least one selected from the group consisting of a plurality of inflation massage levels, a plurality of preset roles, and a plurality of preset modes.

5. The control method for inflating and deflating the air bag according to claim 2, wherein the at least one operation instruction comprises a first operation instruction and a second operation instruction;
the control method for inflating and deflating the air bag further comprises:
controlling the inflation/deflation assembly to deflate the air bag to an initial state in response to the second operation instruction when the second operation instruction is acquired during an operation of the inflation/deflation assembly in response to the first operation instruction;
returning to the step of controlling the inflation/deflation assembly to inflate the air bag in response to the acquired operation instruction, wherein the second operation instruction serves as the acquired operation instruction.

6. The control method for inflating and deflating the air bag according to claim 5, wherein the controlling the inflation/deflation assembly to deflate the air bag to the initial state in response to the second operation instruction comprises:
controlling the inflation/deflation assembly to deflate the air bag for a preset reset deflation duration or until the air pressure value reaches a preset reset air pressure value.

7. The control method for inflating and deflating the air bag according to claim 1, further comprising:
controlling the inflation/deflation assembly to deflate the air bag for a preset power-on deflation duration or until the air pressure value reaches a preset power-on air pressure value when the massager is powered on.

8. The control method for inflating and deflating the air bag according to claim 1, wherein the massager stores inflation massage parameters used a last time before the massager was powered off;
the control method for inflating and deflating the air bag further comprises:
acquiring the inflation massage parameters when the massager is powered on, wherein the inflation massage parameters comprise the preset air pressure value and the preset inflation duration;
wherein the controlling the inflation/deflation assembly to inflate the air bag in response to the acquired operation instruction comprises:
controlling the inflation/deflation assembly to inflate the air bag in response to a power-on signal of the massager.

9. The control method for inflating and deflating the air bag according to claim 1, wherein the at least one operation instruction is capable of being acquired in at least one of the following ways:
receiving the at least one operation instruction sent by a third-party smart device;
receiving the at least one operation instruction sent by a button of the massager, wherein the button generates the at least one operation instruction when triggered by the user; and
receiving the at least one operation instruction generated based on a voice command from the user.

10. The control method for inflating and deflating the air bag according to claim 1, further comprising:
automatically acquiring inflation massage parameters stored during a last massage session after detecting that the user's body part to be massaged has been placed in the air bag for a preset waiting duration, wherein the inflation massage parameters comprise the preset air pressure value and the preset inflation duration;
wherein the controlling the inflation/deflation assembly to inflate the air bag in response to the acquired operation instruction comprises:
controlling the inflation/deflation assembly to inflate the air bag in response to the user's body part to be massaged being placed in the air bag for the preset waiting duration.

11. A massager, comprising:
an air bag, configured to fit a user's body part to be massaged;
an inflation/deflation assembly, connected to the air bag and configured to inflate or deflate the air bag;
an air pressure sensor, configured to detect an air pressure value in the air bag;
a timing circuit, configured to detect an inflation duration of the inflation/deflation assembly; and
a control circuit, electrically connected to the air pressure sensor, the timing circuit, and the inflation/deflation assembly and configured to:
control the inflation/deflation assembly to inflate the air bag in response to an acquired operation instruction, wherein the acquired operation instruction is one of at least one operation instruction; and
control the inflation/deflation assembly to stop inflating the air bag when the air pressure value reaches a preset air pressure value or when the inflation duration reaches a preset inflation duration, and control the inflation/deflation assembly to deflate the air bag.

12. The massager according to claim 11, wherein the control circuit is further configured to determine the preset air pressure value and the preset inflation duration corresponding to the acquired operation instruction.

13. The massager according to claim 12, wherein the number of the at least one operation instruction is more than one, and the number of groups of the preset air pressure value and the preset inflation duration is more than one;
the preset air pressure value corresponds to one of the more than one operation instruction is different from the preset air pressure value corresponds to another of the more than one operation instruction, and/or the preset inflation duration corresponds to the one of the more than one operation instruction is different from the preset inflation duration corresponds to the another of the more than one operation instruction.

14. The massager according to claim 13, wherein each of the more than one operation instruction corresponds to at least one selected from the group consisting of a plurality of inflation massage levels, a plurality of preset roles, and a plurality of preset modes.

15. The massager according to claim 12, wherein the at least one operation instruction comprises a first operation instruction and a second operation instruction; the control circuit is further configured to:
control the inflation/deflation assembly to deflate the air bag to an initial state in response to the second operation instruction when the second operation instruction is acquired during an operation of the inflation/deflation assembly in response to the first operation instruction;
return to execute the step of controlling the inflation/deflation assembly to inflate the air bag in response to the acquired operation instruction, wherein the second operation instruction serves as the acquired operation instruction.

16. The massager according to claim 15, wherein the control circuit is further configured to:
control the inflation/deflation assembly to deflate the air bag for a preset reset deflation duration or until the air pressure value reaches a preset reset air pressure value in response to the second operation instruction.

17. The massager according to claim 11, wherein the control circuit is further configured to:
control the inflation/deflation assembly to deflate the air bag for a preset power-on deflation duration or until the air pressure value reaches a preset power-on air pressure value when the massager is powered on.

18. The massager according to claim 11, further comprising a memory for storing inflation massage parameters used the last time before the massager was powered off; the control circuit is electrically connected to the memory and is further configured to:
acquire the inflation massage parameters when the massager is powered on, wherein the inflation massage parameters comprise the preset air pressure value and the preset inflation duration; and
control the inflation/deflation assembly to inflate the air bag in response to a power-on signal of the massager, wherein the power-on signal serves as the acquired operation instruction.

19. The massager according to claim 11, wherein the control circuit is capable of acquiring the at least one operation instruction in at least one of the following ways:
receiving the at least one operation instruction sent by a third-party smart device;
receiving the at least one operation instruction sent by a button, wherein the massager comprises the button electrically connected to the control circuit, and the button generates the at least one operation instruction when triggered by the user; and
receiving the at least one operation instruction sent by a voice circuit, wherein the massager comprises the voice circuit electrically connected to the control circuit, the voice circuit generates the operation instruction after receiving a voice command from the user.

20. The massager according to claim 11, further comprising a detection circuit configured to detect whether the user's body part to be massaged is placed in the air bag;
the timing circuit is further configured to detect a placement duration of the user's body part to be massaged in the air bag;
the massager further comprises a memory for storing inflation massage parameters used during a last massage session;
the control circuit is electrically connected to the detection circuit and the memory and is further configured to:
acquire the inflation massage parameters when the placement duration reaches a preset waiting duration, wherein the inflation massage parameters comprise the preset air pressure value and the preset inflation duration;
control the inflation/deflation assembly to inflate the air bag in response to a signal indicating that the placement duration reaches the preset waiting duration, wherein the signal serves as the acquired operation instruction.
